(19) United States
(12) Patent Application Publication
(10) Pub. No.: US 2011/0137669 A1
(43) Pub. Date: Jun. 9, 2011

(54) SYSTEM AND METHOD FOR MANAGING A LEADERSHIP AND HEALTH DEVELOPMENT PROGRAM

(75) Inventor: Joel B. Bennett, Fort Worth, TX (US)

(73) Assignee: Organizational Wellness & Learning Systems, Inc., Fort Worth, TX (US)

(21) Appl. No.: 12/630,904

(22) Filed: Dec. 4, 2009

(51) Int. Cl. G06Q 50/00; G06F 3/01; G06Q 10/00

(52) U.S. Cl. 705/2; 715/760

(57) ABSTRACT

A system and method are provided for managing a leadership and health development program. The system includes a network configured to provide a plurality of members of an organization access to the computer system. At least one of the plurality of members is a leader. The system further includes a computer having a web server configured to provide a plurality of web pages over the network, and a database in communication with the web server and having a plurality of leadership and health and wellness programs targeted toward the at least one leader. The web server is configured to deliver one or more leader surveys in a plurality of health and wellness categories and a plurality of leadership and management categories to the at least one leader via the plurality of web pages, receive a plurality of leader responses corresponding to the one or more leader surveys from the at least one leader, calculate a first leader level of health and leadership in different dimensions of the at least one leader based on the plurality of leader responses, and graphically represent and deliver the first leader level of health and leadership to the at least one leader via the plurality of web pages.

### BACKGROUND OF THE INVENTION

1. Field of the Invention

The present invention relates to leadership and health development programs and more particularly to a system and method for managing a program that provides and integrates leadership development and health promotion to individuals and organizations.

2. Discussion of the Background

It is often helpful for organizations to improve the leadership skills and health of its leaders. The balance between developing a leader's skills and maintaining or improving the leader's health is paramount for his or her professional success. Improved leadership skills and health for leaders of an organization may also potentially impact the entire organization through the leader's positive leadership behaviors, healthy lifestyle, and the support of others in their effort to improve their own health. Leadership skills programs that are known in the prior art generally provide little or no focus on making corrections and/or improvements to the healthy lifestyle of the leader. Health promotion programs that are known in the prior art generally provide little emphasis on the unique health risks of managers and the special role managers play in promoting wellness.

Thus, there currently exists deficiencies in leadership development and health promotion programs that are known in the prior art.

### SUMMARY OF THE INVENTION

Accordingly, one aspect of the present invention is to provide a system for managing a leadership and health development program. The system includes a network configured to provide a plurality of members of an organization access to the computer system. At least one of the plurality of members is a leader. The system further includes a computer having a web server configured to provide a plurality of web pages over the network, and a database in communication with the web server and having a plurality of leadership and health and wellness programs targeted toward the at least one leader. The web server is configured to deliver one or more leader surveys in a plurality of health and wellness categories and a plurality of leadership and management categories to the at least one leader via the plurality of web pages, receive a plurality of leader responses corresponding to the one or more leader surveys from the at least one leader, calculate a first leader level of health and leadership in different dimensions of the at least one leader based on the plurality of leader responses, and graphically represent and deliver the first leader level of health and leadership to the at least one leader via the plurality of web pages.

Another aspect of the present invention is to provide a method of managing and providing a leadership and health development program to a plurality of members of an organization. At least one of the plurality of members is a leader. The method is implemented by one or more processors executing processor instructions stored on a computer readable medium, the method includes the following processor implemented steps of providing a web server configured to provide a plurality of web pages over a network, delivering one or more leader surveys in a plurality of health and wellness categories and a plurality of leadership and management categories over the network to the at least one leader via the plurality of web pages, receiving a plurality of leader responses corresponding to the one or more leader surveys from the at least one leader, calculating a first leader level of health and leadership in different dimensions of the at least one leader based on the plurality of leader responses, and graphically representing the first leader level of health and leadership via the plurality of web pages.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1, 2A and 2B are block diagrams illustrating the overall system according to an embodiment of the present invention;

FIGS. 3A-3D are flow charts generally illustrating the overall system functionality according to an embodiment of the present invention; and

FIGS. 4A-4B illustrate an exemplary computer program for managing a leadership and health development program according to an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

The present invention provides an Internet-based system and computer program that facilitates delivery of health promotion programs to organizations to reduce leader and employee health risks, including without limitation risks associated with cardiovascular disease. As used herein, a “leader” is intended in its broadest sense and includes without limitation a principal, an owner, a manager, an executive, a section head, a team lead, an influential employee or anyone else having influence over others in an organization. As used herein, an “organization” represents a business entity, and may include any one or more of a number of worksites, departments, regions, or specific work groups identifiable within each of those designations or the organization as a whole or by virtue of location, occupation, or any other identifiable aspect of work whereby two or more individuals share membership. Leaders present significant medical savings to an organization through at least three positive paths of influence: (1) they can provide supportive supervision and positive leadership, a known health protective factor in the work environment; (2) they can model heart healthy life-styles to associates (i.e., role modeling); and (3) leaders make decisions about whether employees will receive health promotion programs, and the leaders may encourage or support the use of such programs by other member of an organization.

The present invention provides a computer program, known as ExecuPrev™, that is designed to enhance positive changes within each of these paths of influence. To appeal to leaders, the computer program integrates and aligns health messages within a business-relevant leadership development program. The design and content of the computer program draws on the empirical relationship between a healthy life-style and known behavioral risks in leaders, such as without limitation stress, social isolation and the inability to deal with crisis or failures, and provides interactive exercises that features expert opinions and integrates leadership tips with tools for recognizing and addressing psycho-social risks for cardiovascular disease (“CVD”). As part of the integration of leadership with health promotion, the computer program provides an organization with a series of e-health modules on stress, diet, nutrition, and active lifestyle that can be used by leaders and other members of the organization. Moreover, a series of “take action” guides provides specific instructions so that leaders and/or other members of an organization can implement ideas learned from reviewing messages, expert opinions, and various downloadable “learn more” documents embedded in the program.

The computer program may be used by an organization to teach the concept of true healthy leadership and provide leaders and/or other members of an organization, tools to implement the concept. According to one embodiment, the computer program uses two core models: “LiveWell” and “LeadWell.” LiveWell is configured to help identify lifestyle areas that either contribute to poor health, or increase vitality in a leader or the workers of a leader. LeadWell is configured to help a leader identify how key virtues and principles—and their expression through management behaviors—can magnify the leader's personal impact as an effective leader. The computer program also provides a leader with personal access to web-based health programs, such as, without limitation, programs that address stress, diet, nutrition, and active lifestyle.

More specifically, LiveWell is configured to identify the outward ripple effect of a leader's health and includes without limitation the following steps: (i) identifying health risks; (ii) identifying strengths and by how much these offset the leader's health risks; (iii) determining the leader's overall level of health and in different dimensions of health including, without limitation, determining physical, psychological, spiritual, and ethical dimensions of health; and (iv) determining the leader's vitality and the leader's perceived vitality of the organization.

LeadWell is configured to identify the inward ripple effect of a leader's leadership and includes without limitation the following steps: (i) identifying motives or what drives the leader to be successful; (ii) examining how the leader tends to interact with his or her team, including the leader's style or focus of interaction; (iii) identifying the leader's impact, including how the leader believes other members of the organization would rate his or her health contribution to the work climate compared with what other members actually believe; and (iv) identifying how the leader practices particular virtues. In one embodiment, examples of virtues include humility, authenticity, integrity, self-care, and open-mindedness.

The present invention recognizes that leaders (at any level of job status or responsibility) make a profound impact on their organization by simply improving their health, leadership, and decisions about work. Improved leadership skills and health for leaders of an organization impacts the entire organization through the leader's positive leadership behaviors, healthy lifestyle, and by supporting the efforts of other members of the organization to improve their own health. This is known as a “ripple effect.” A ripple effect may be initiated with the leader's action or change in habit. Those affected by the ripple effect include, without limitation, the leader's organization, team or family. An organization, such as a corporation, may be affected by key people in the organization making subtle changes in health and interpersonal behavior.

There are many methods of health, leadership, and decisions in an organization. One method is “role modeling” or demonstrating health to others. Leaders may participate in an organization's health initiatives, display supportive leadership, openly discuss their efforts to live a healthy life, or even share about their own leadership development. Leaders can act as role models to their organization in many ways. Another method requires the leader to actively support health promotion within an organization, and includes the leader attending activities, encouraging members of the organization to attend, and/or recognizing and rewarding healthy behaviors of others within the organization. For instance, if an organization doesn't have a wellness program, the leader may form a committee to start one. Yet another method involves decisions leaders make about the work setting, such as how work is organized, and includes job design, work flow, empowerment, and reward. For example, Table 1 summarizes four different work dimensions that impact employee health and stress and also through which leaders can provide possible remedies.

TABLE 1
Four Dimensions of a Work Setting

| Work Dimension | Brief Description | Possible Remedies |
|---|---|---|
| REDUCE JOB DEMAND + | A job with heavy workload, a | Wherever possible, allow the |
| INCREASE JOB CONTROL | fast work pace, or strict | leader's associates some |
| | timelines is considered high | decision making latitude on |
| | demand. This combined with | the job. Allow associates |
| | very little decision-making | control over the day-to-day |
| | ability, autonomy, or control | decisions that impact their |
| | can be cause for increased | work. Encourage team-based |
| | health risks (i.e. | decision making. Modify |
| | cardiovascular risk, | work flow to be more |
| | exhaustion, and depression). | efficient, giving workers a |
| | | chance to stretch. |
| REDUCE EFFORT + | When workers feel an | Be sure employees are aware |
| INCREASE REWARD | imbalance between (a) the | of their professional |
| | level of effort required to do a | development path, keep them |
| | job and (b) job rewards (i.e. | up-to-date on their |
| | promotion, money, self- | performance, recognize |
| | esteem) they are at greater risk | positive work behaviors and |
| | of health effects (such as | achievements, and implement |
| | increased risk for heart | a clear and consistent reward |
| | disease). | system. |
| INCREASE SOCIAL | Social support can be defined | Start a mentorship program |
| SUPPORT | as proactive communication, | that will allow employees with |
| | care and understanding. The | management potential to work |
| | leader can receive support | with leadership on their |
| | from family, friends, | managerial skills. Initiate |
| | colleagues, and mentors. | team-based activities that |
| | Workers with low levels of | encourage camaraderie. |
| | support are at risk for | |
| | productivity loss and health | |
| | problems. | |
| REDUCE PERCEIVED | Some workers may feel they | There are many types of |
| STATUS DISCREPANCY | are in a job that does not | empowerment programs that |
| (ALIENATION) | match their needs for | give workers a sense of |
| | achievement, power, or | influence and contribution |
| | influence. They feel they can | even if they are in “low status” |
| | never get ahead or contribute | positions. Find ways to give |
| | as much as they could. | workers tasks that allow them |
| | | to express their needs in |
| | | satisfying ways. |

Leaders have an opportunity to start each day with positive improvements in their behavior. A ripple effect involves the decisions leaders make within their organization, including their immediate work group, colleagues, direct reports, or customers. These decisions follow a leader's intent on how well the leader treats himself/herself, others, and the work setting.

The computer program provides leaders with all they need to know, and do, to become a healthy leader, including without limitation (i) multi-media lessons with post-lesson “knowledge checks” and “learn more” documents or downloadable executive summaries that provide more detail on the lesson, (ii) take action assignments including a series of chapters that comprise a full “take action” curriculum, (iii) self-assessments, and (iv) various LeadWell and LiveWell tools. Using the present invention, leaders gain a clearer understanding of those key actions that positively shape their leadership, their career, and the success of their workplace.

The present invention includes one or more health assessments, including without limitation a self assessment, and a peer or team assessment. According to one embodiment, various health-related assessment aspects are given numerical scores. Specifically, the health assessment includes numerical scores ranging from 1 to 5:
(1) Problem: My own health brings problems to the group.
(2) Risk: My own health brings risks to the group.
(3) Adapting: My group and I are just getting by; we don't have problems but we are not really healthy either.
(4) Healthy: My own health brings strengths to the group.
(5) Resilient: My own health helps make the group strong, productive, and resilient.

The present invention includes without limitation an activity planner, a curriculum, one or more assessments, and a dashboard that automatically displays results gathered from responses to the assessment by leaders and/or other members of the organization.

The activity planner may be used by a leader to indicate interest in self-assessments, take action guides, health promotion programs, or other curricula and to then set up a schedule for following up on this interest. Interests may include, for example, taking one or more self-assessments, implementing a take action guide, or using a health promotion program. A decision tracker may be used to keep track of the leader's interests and actions, and the leader's completion date for one or more of the activities.

A leader may set-up a curriculum with respect to the self-assessments and one or more lessons. Each successive chapter refers to a self-assessment or other activity/method that has the goal of enhancing the positive “ripple effect” as discussed above.

According to one embodiment, LiveWell assessments build upon each other and each provide a leader with a total score (e.g., a total score ranging from “20” to “100”) such that the leader can review how the components relate to each other. A profile is built as the leader progresses from one assessment to the next. A leader is asked to think about how his or her own motives influence the leader's strategy and then whether the leader is leading “from within” in accordance with personal principles and virtues.

The two profiles (LeadWell and LiveWell) can be printed out and compared. Based on the review of the profiles, one or more recommendations, such as a coaching call, may be recommended. The two models (LeadWell and LiveWell) influence and reinforce each other, and seek to embrace the leader as a whole person. Using the present invention, many things become important to a leader: the leader's vision, the leader's character or the way the leader acts with virtue, the leader's drive for success, the leader's needs for power and influence, and the leader's ability to handle the complex demands of work and working with people who look for the leader's positive leadership. At the same time, when a leader is healthy, these things are easier to work with. As a whole person, the leader's ability to lead depends on a healthy understanding of the leader's leadership motives, the leader's leadership style, and whether or not the leader has an accurate perception of how he/she comes across to the leader's workers.

LiveWell and LeadWell profiles record the date of the leader's previous two assessments and displays the leader's previous and current assessments. According to one embodiment, previous assessments are “ghosted” or in a lighter, transparent color so the leader can compare it with the current score. In other words, the profiles are designed for continual re-assessment. The present invention is configured to provide the leader with information on whether or not the leader changes, improves, or receives lower scores over time. Such re-assessment is critical and is the basis for improving the return on investment (“ROI”) of any leadership development program. The present invention provides the leader with information regarding when and how the leader improves from his or her efforts.

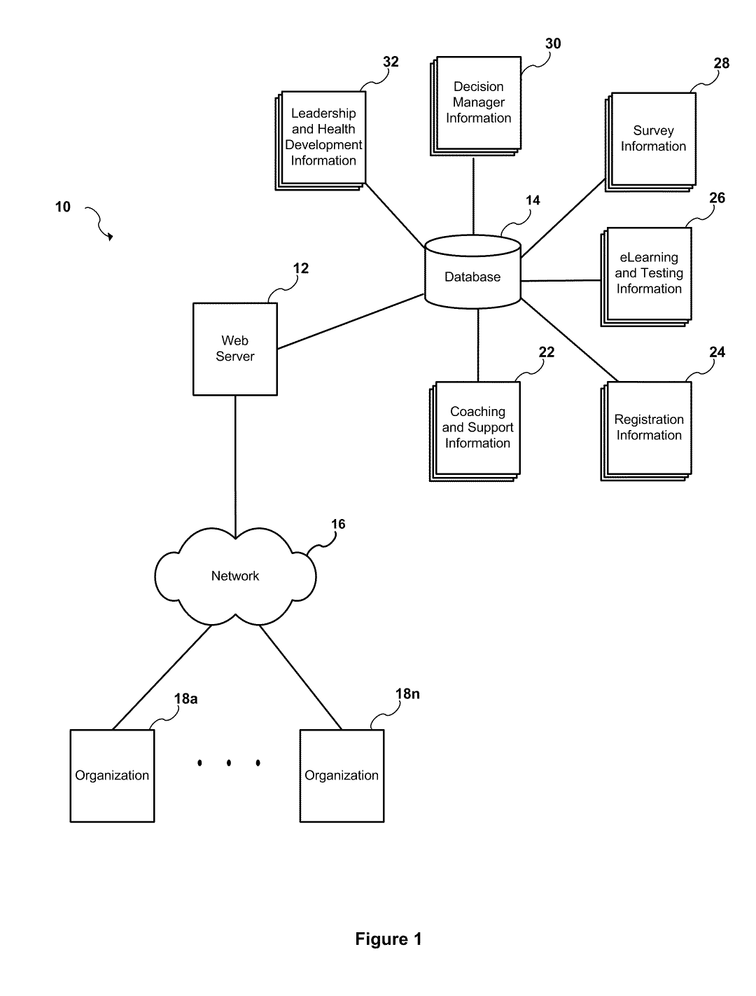

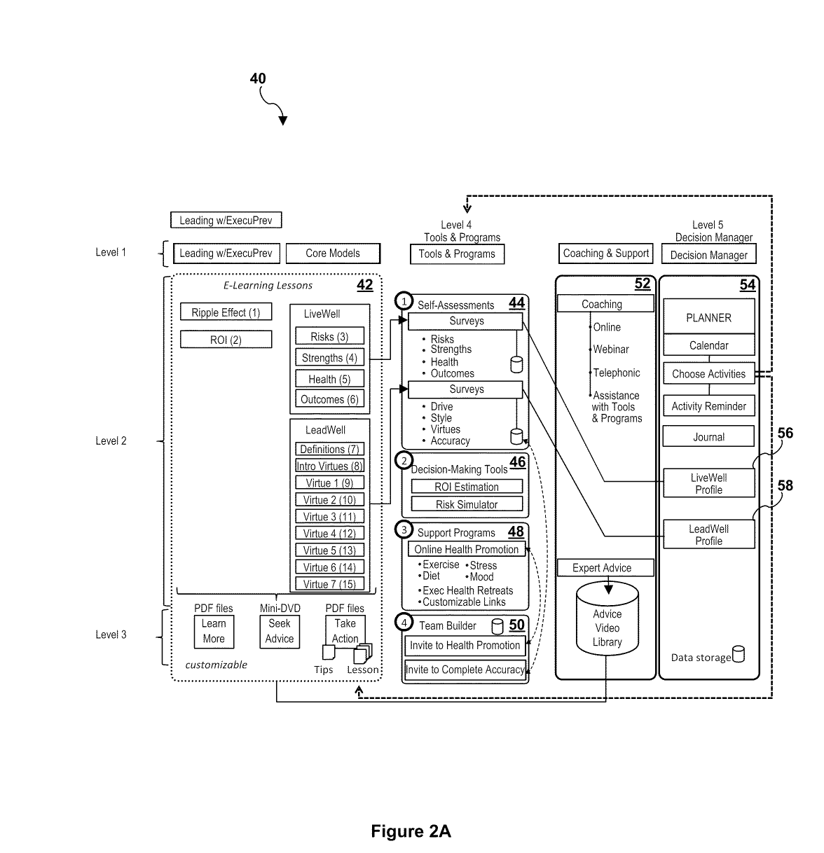

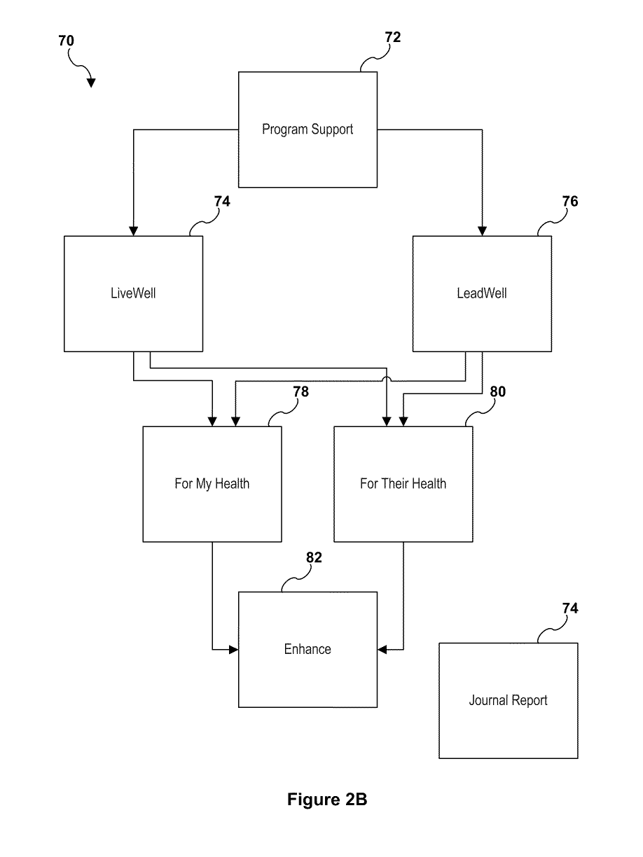

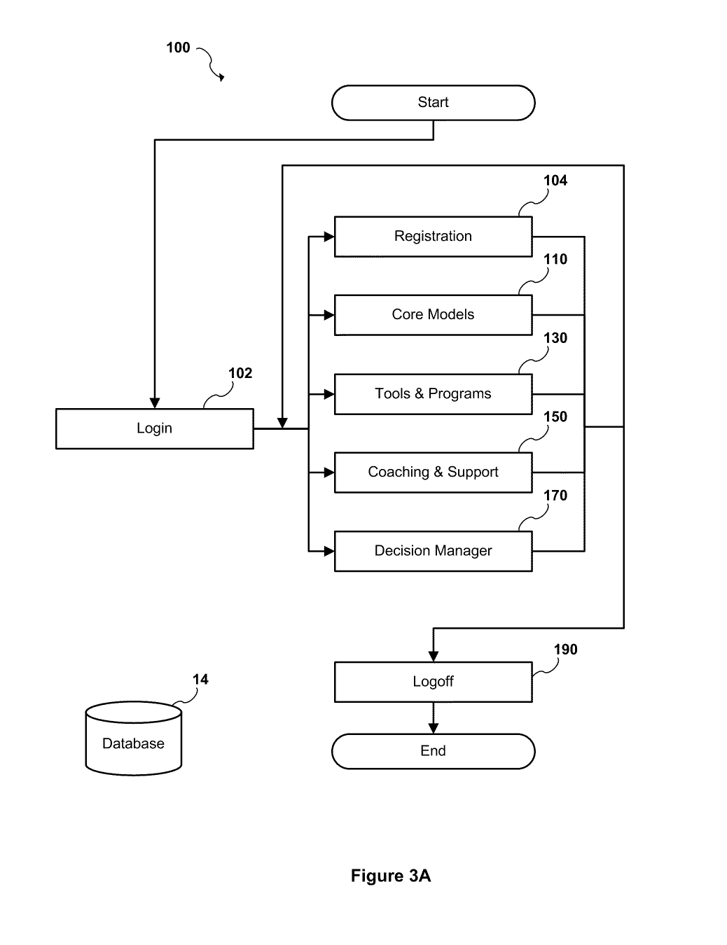

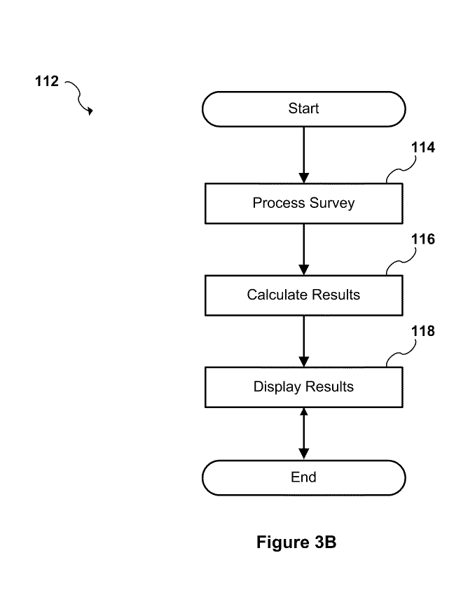

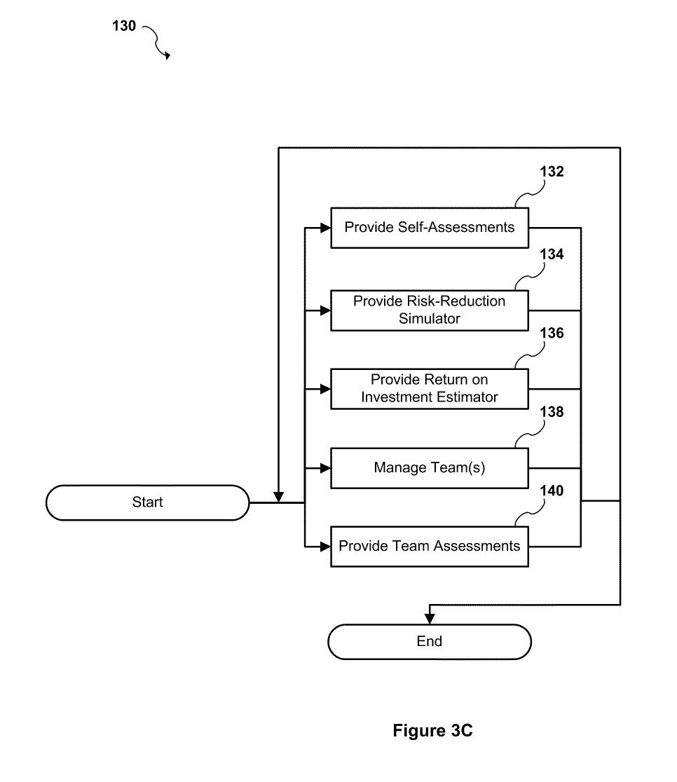

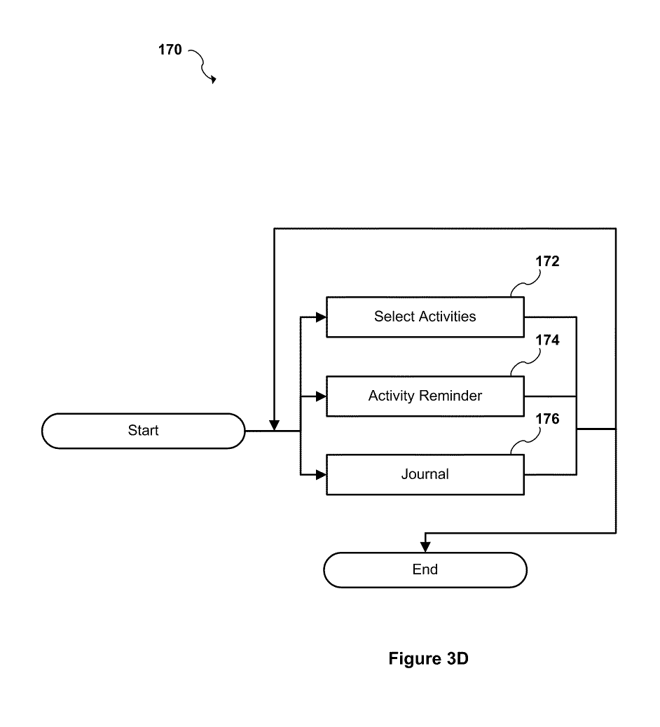

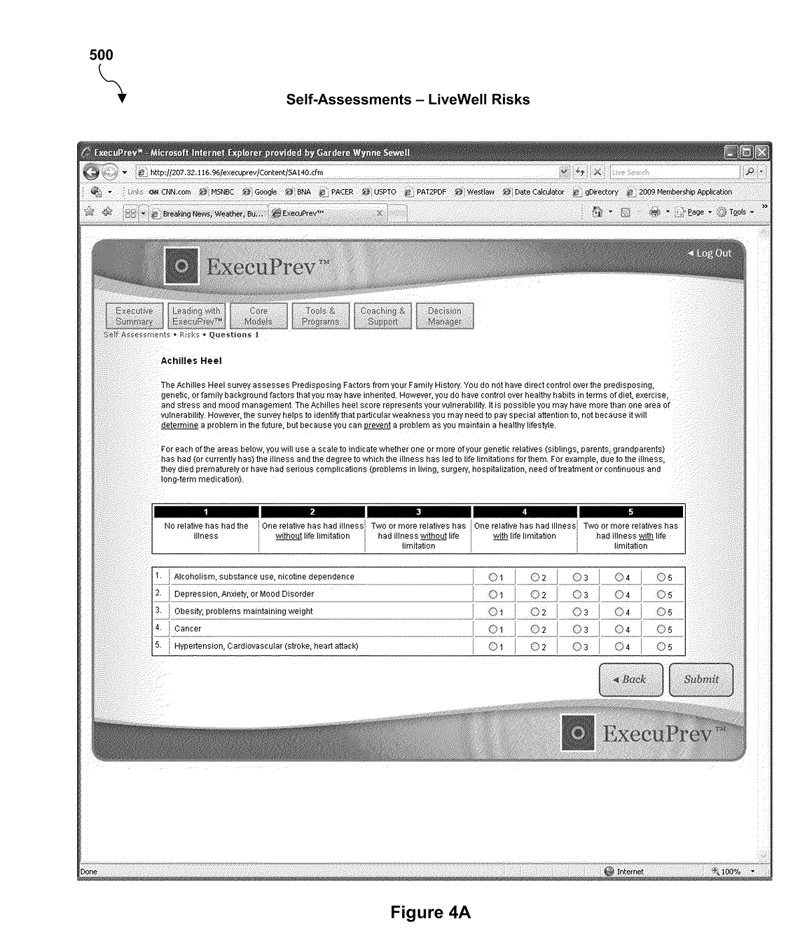

Referring to FIGS. 1 and 2, block diagrams illustrating the overall system 10 according to an embodiment of the present invention are shown. The present invention relates to a system and method for managing a leadership and health development program using a computer program. The system 10 includes a computer or other hardware executing a web server 12. The web server 12 is in communication with one or more databases 14 containing leadership and health development related information. For instance, the one or more databases 14 may include, without limitation, coaching and support information 22, registration information 24, eLearning and testing information 26, surveys 28, decision leader information 30, and information relating to leadership and health development 32. One or more organizations (18a-18n) are in communication with the web server 12 over a network, including without limitation, the Internet 16, Intranet or other compatible network. One or more organizations (18a-18n) utilize the web-based system to provide leadership and health development to a leader or leader. In one embodiment, the web-based system may be used to prepare (or mentor) leaders and/or other members of an organization for future leadership, correct and/or improve the leadership and health of a current leader, as well as improve the health of a particular work group, work department, or organization.

The present invention is generally based on the following concepts: e-Learning lessons, self-assessments, decision manager information, coaching & support, and leadership and health development, as shown in blocks 22-32. Referring to FIG. 2A, one possible configuration of the invention (block 40) is shown. These concepts may be applied across five progressive levels of instruction or exploration for users. In other words, busy leaders who may not have time to fully explore and apply concepts may access tools or sections in brief steps at first and, depending on interest or needs, explore in greater depth and requiring progressively greater investment. These tools or sections include e-learning lessons (block 42) self-assessments (44), decision-making tools (46), support programs (48), the team builder (50), coaching and support (52), a planner (54), and the displays or profiles from the self-assessments for LiveWell (56) and LeadWell (58). The invention includes a navigable site map with “point and click” buttons that link the user directly to sections as displayed in FIG. 2A.

Self-assessments 44 is configured to store scores from most recent and previous surveys for all eight surveys in the system (including the LMA). Team Builder 50 is configured to store e-mails selected and record e-mails sent as well as track use of the online health promotion by members of the organization (i.e., the invitees). Coaching and support 52 may include an Expert Advice Library which includes one or more video-clips. Any of these video-clips can be replaced at any time. Similarly, the learn more and take action guides can be replaced at any time. Planner 54 is configured to store dates, send dates to activity reminder. Planner 54 may also link other sections.

At level 1, leaders and/or other members of the organization watch brief multi-media introductions to concepts. At level 2, leaders and/or other members of the organization can explore lessons associated with concepts—especially for the core models of LiveWell and LeadWell. At level 3, for both of the core models, leaders and/or other members of the organization can Learn More, Seek Advice, and Take Action on concepts from the lessons. At level 4, leaders and/or other members of the organization can access tools and programs referenced in the Take Action guides. For example, leaders can initiate an invitation to other members of an organization to (i) use online health promotion tools that are directly accessible to associates, or (ii) complete anonymous surveys asking associates for their perceptions of the leader. According to one embodiment, the Take Action guides have three-levels of depth: Tips, Level 2 Guide, and Level 3 curriculum. At level 5, leaders can use a calendar to plan these activities, choose courses of action, consult their profiles for areas needing focus, and journal about their experience.

### E-Learning

As shown at block 42, the present invention includes e-Learning. e-Learning may include, without limitation, one or more online tutorials configured to improve the user's current knowledge on living well and leading well. According to one embodiment, e-Learning is a part of the core models presented to the leader. However, the above description is not intended to represent all e-learning functions and other functions are possible within the scope of the present invention. For example, other e-learning functions may include sub-program self-assessment surveys for the leader that provide statement inputs and numerical and/or graphical outputs, as represented, in block 40, by arrow linkages from lessons (42) to surveys (44) to profiles displays (56, 58).

### Self-Assessments

As shown at block 132, the present invention includes one or more assessments. Self-assessments may be performed via one or more surveys. The self-assessments may occur at any time. The self-assessments include computing intermediate numerical scores based on responses provided during the self-assessments, and generating LiveWell and LeadWell profiles (56 and 58) using the intermediate numerical scores. The LiveWell and LeadWell profiles (56 and 58) may be graphically represented to the user.

According to one embodiment, self-assessment surveys for LiveWell include without limitation risks, strengths, health and outcome surveys. Self-assessment surveys for LeadWell include without limitation leadership drive/energy, leadership style/focus, inner work and accuracy surveys.

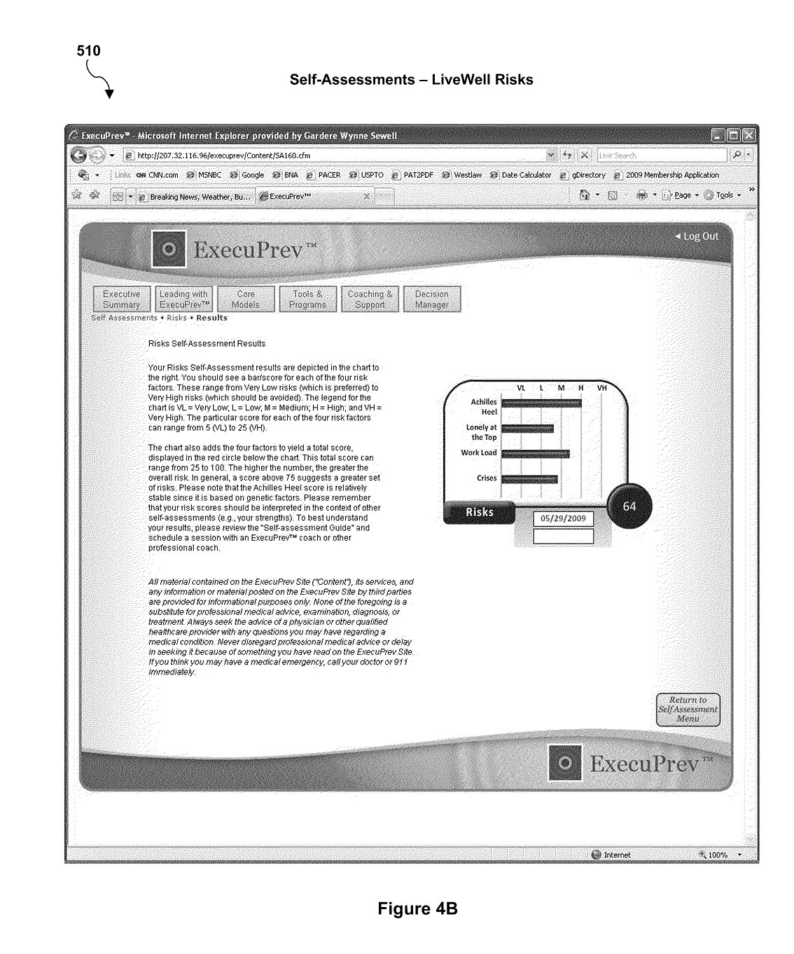

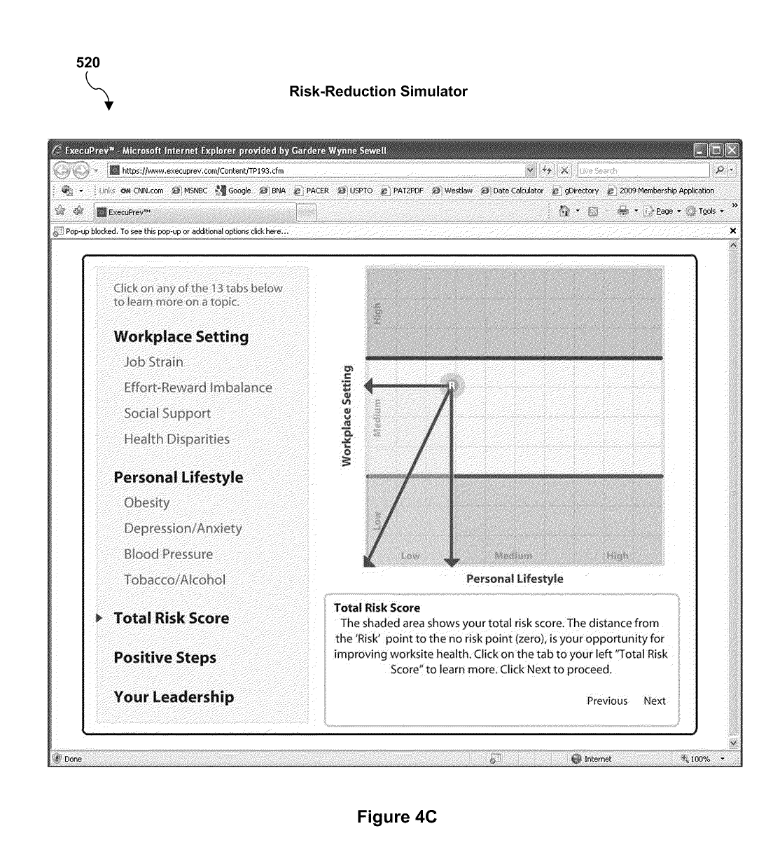

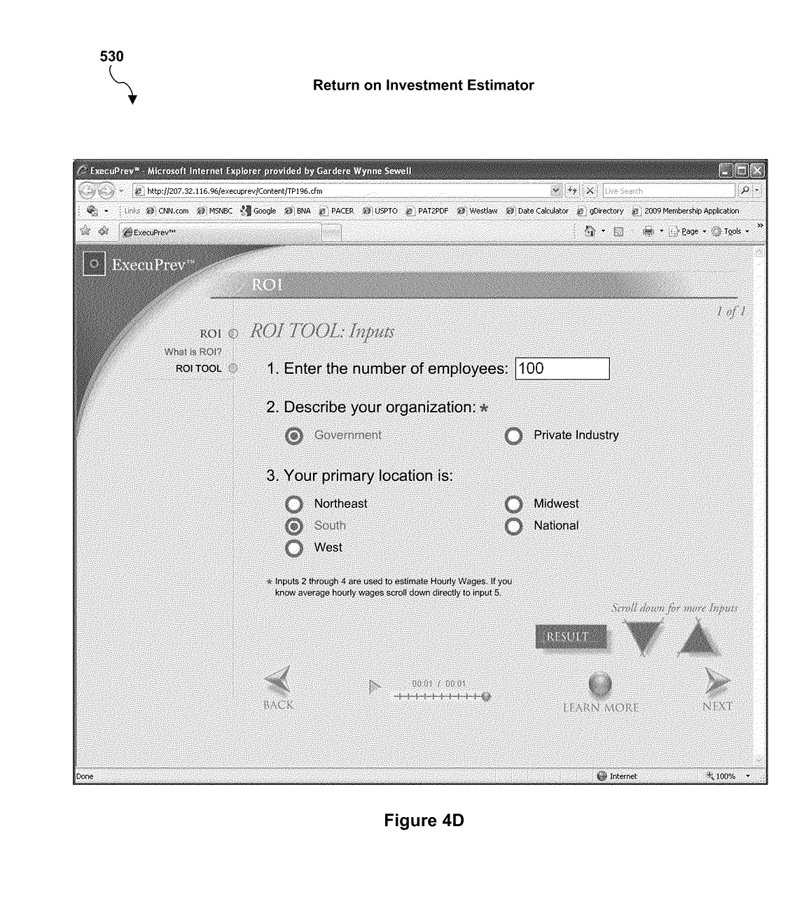

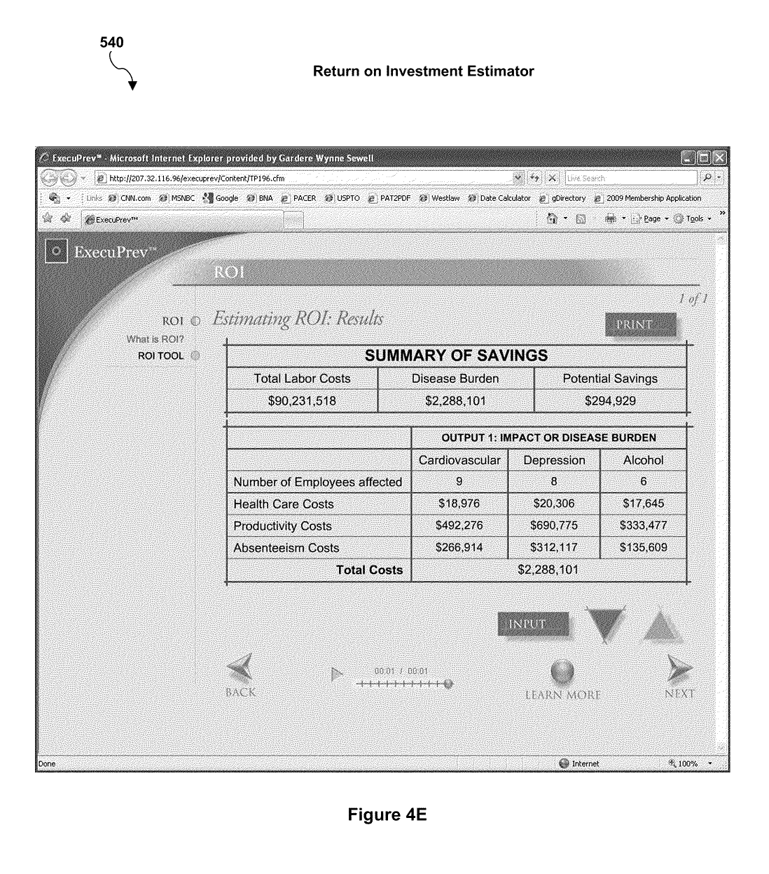

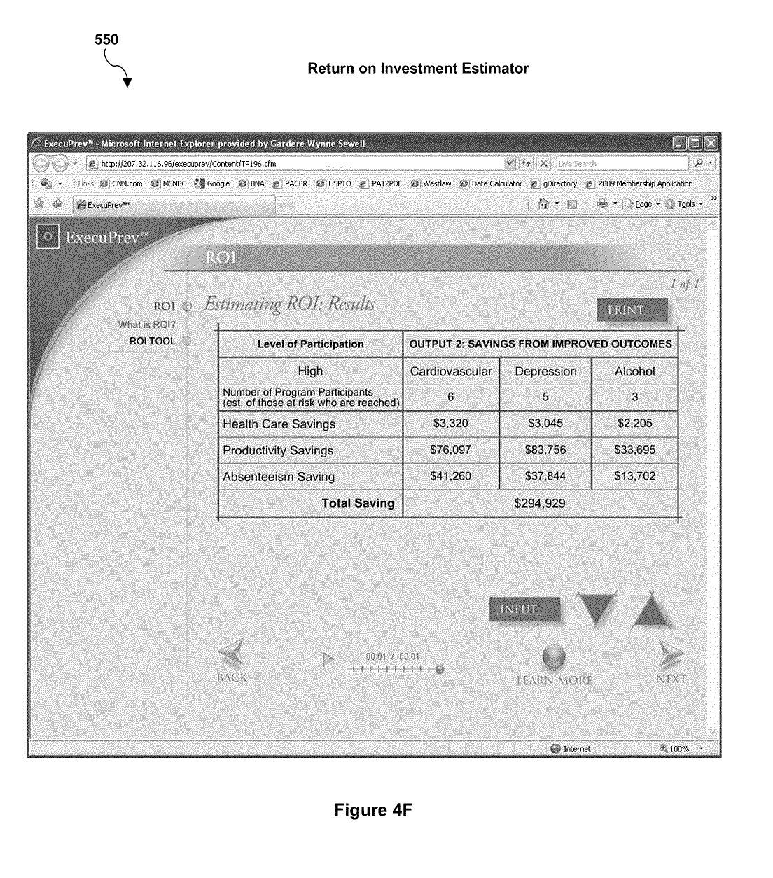

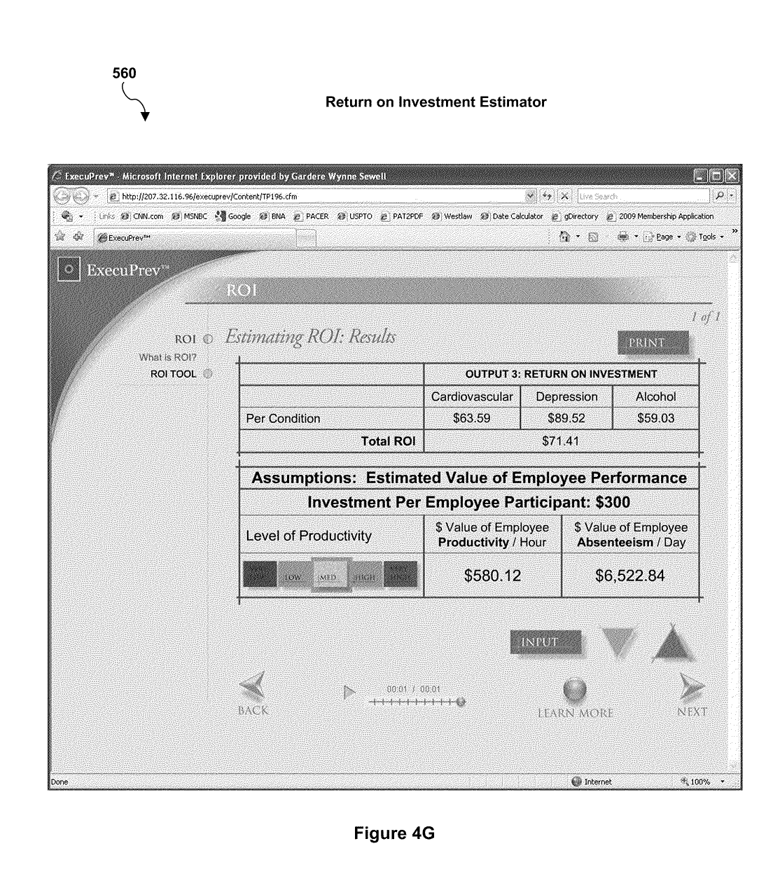

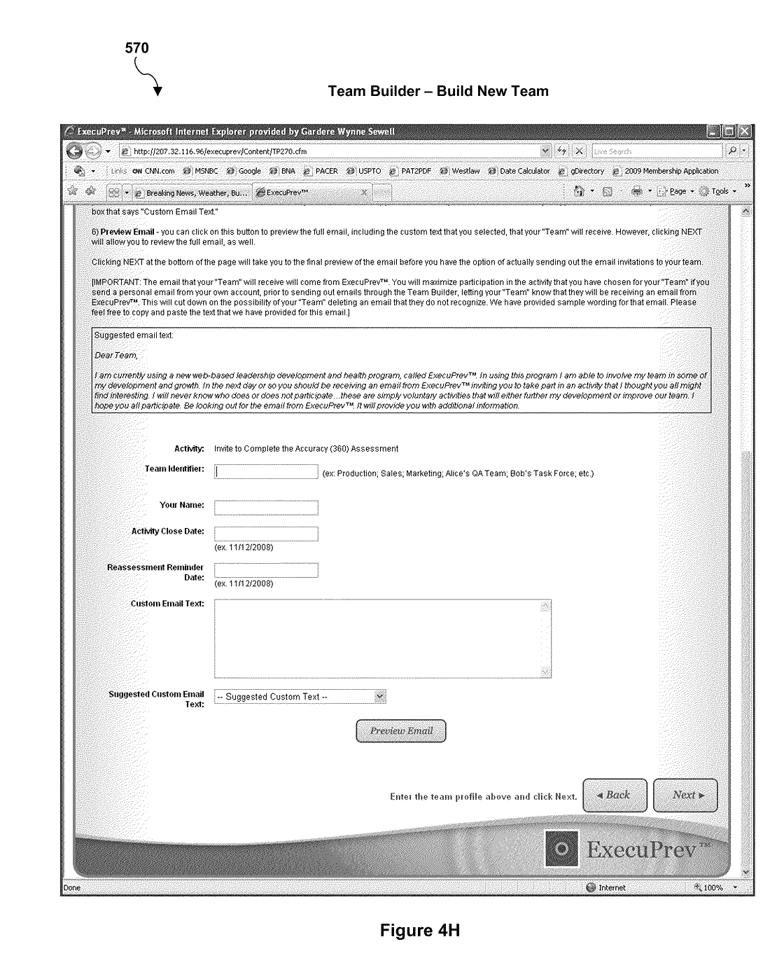

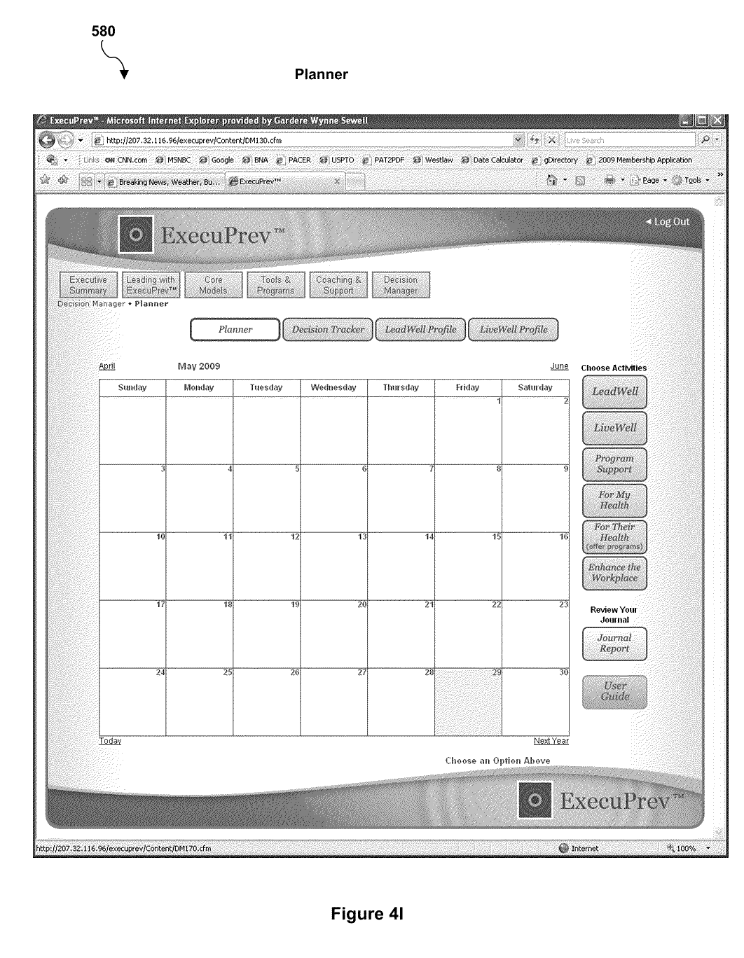

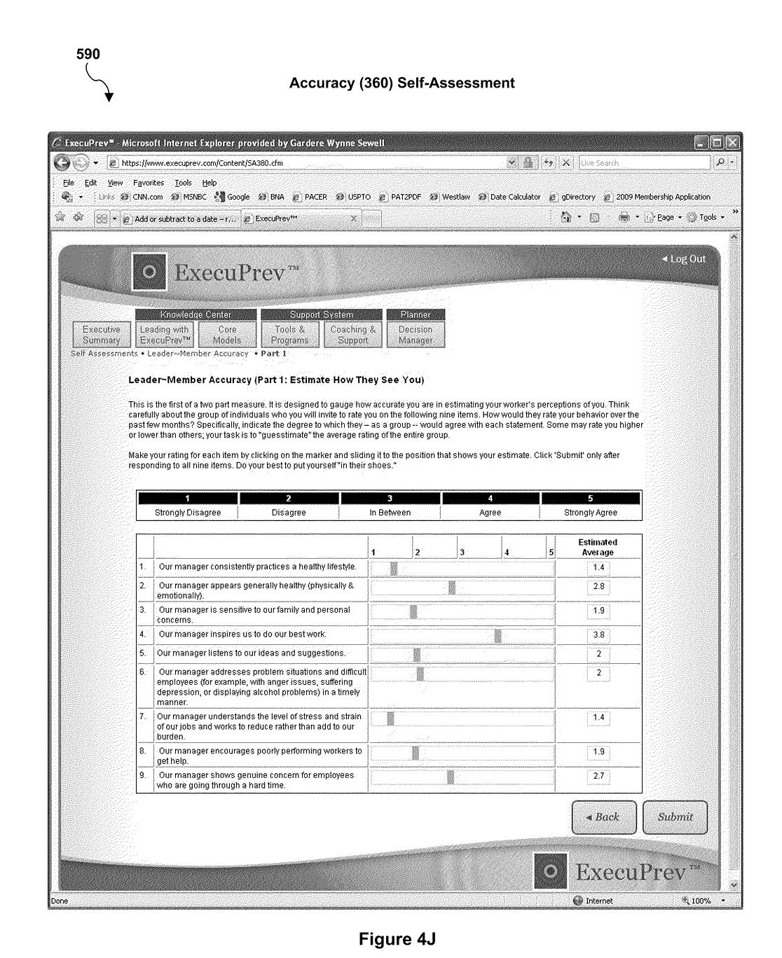

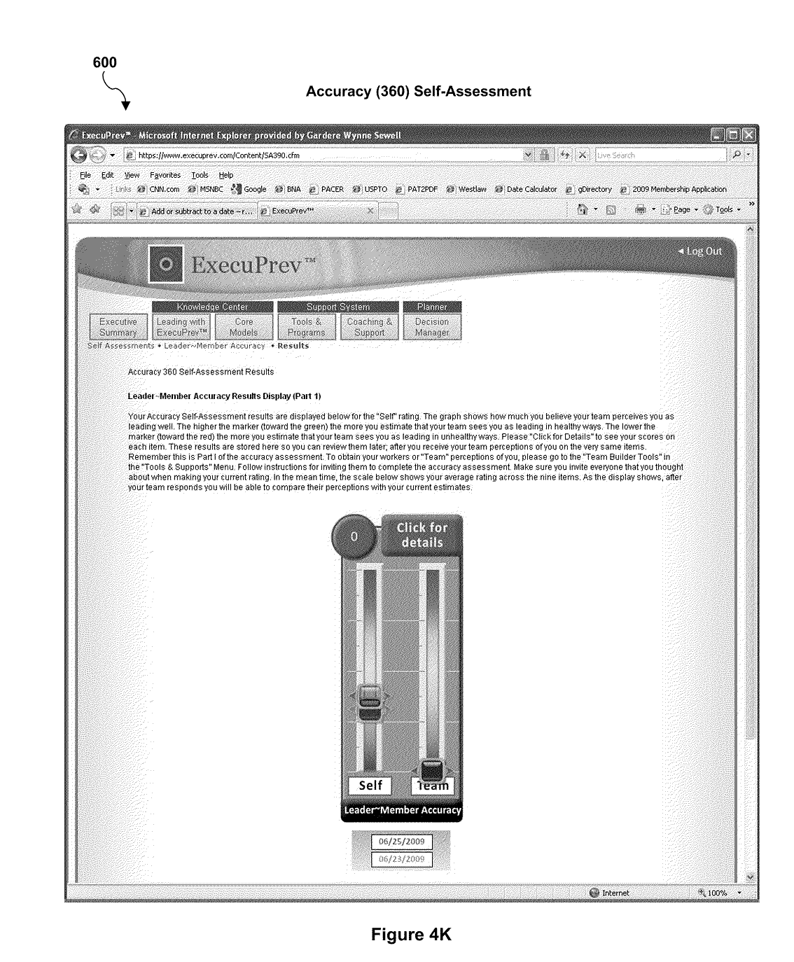

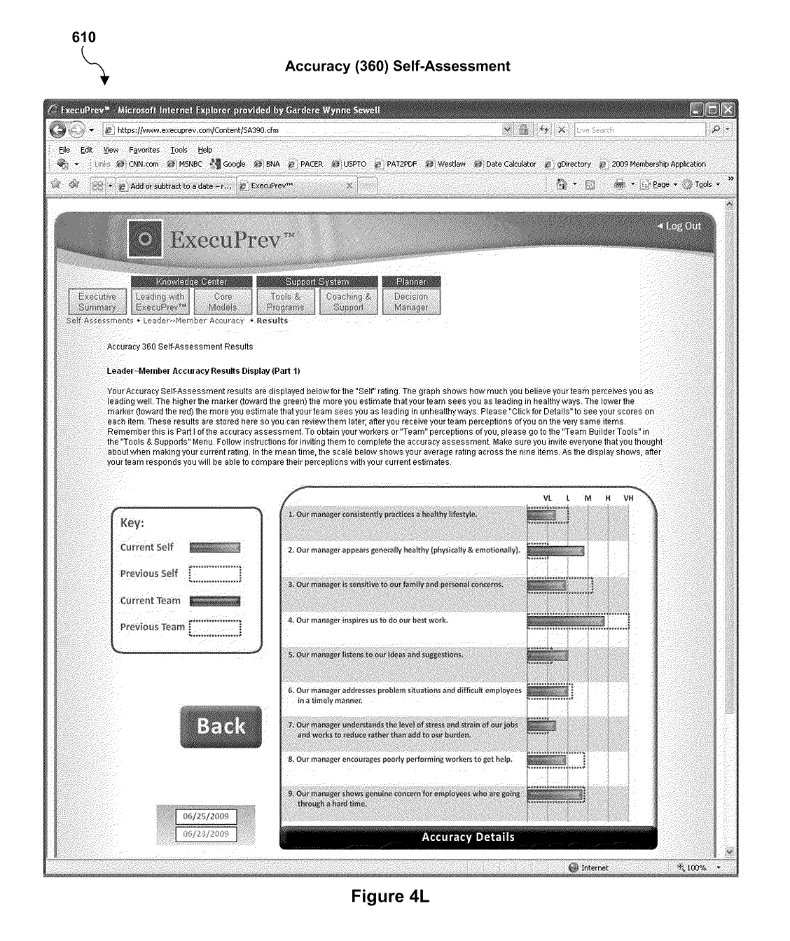

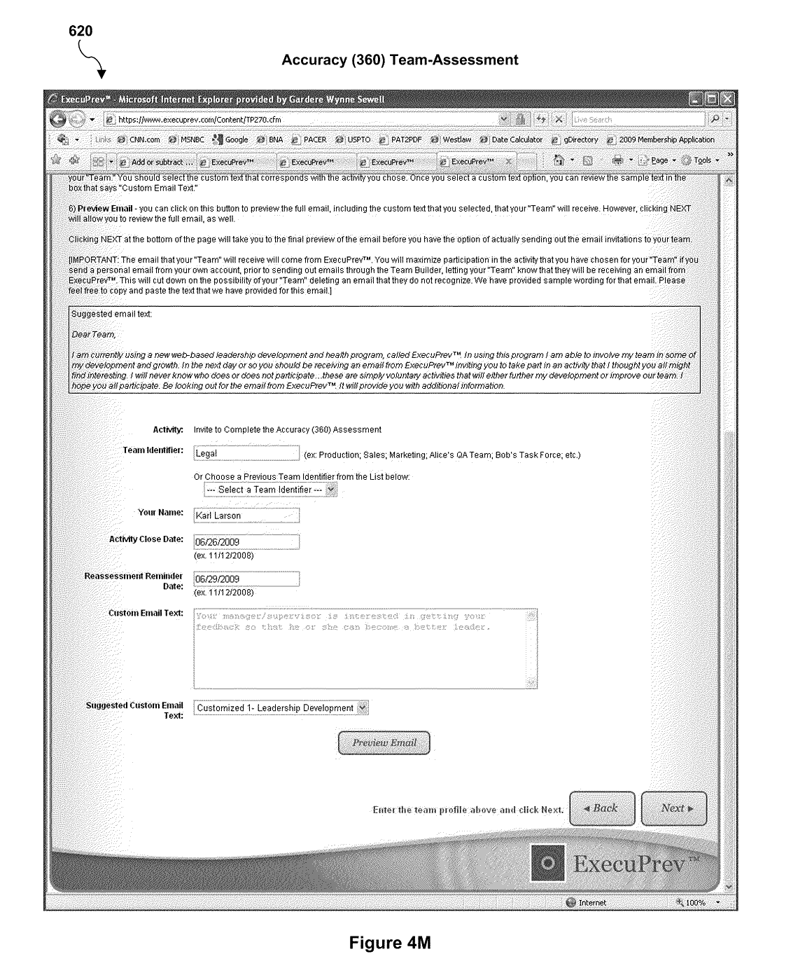

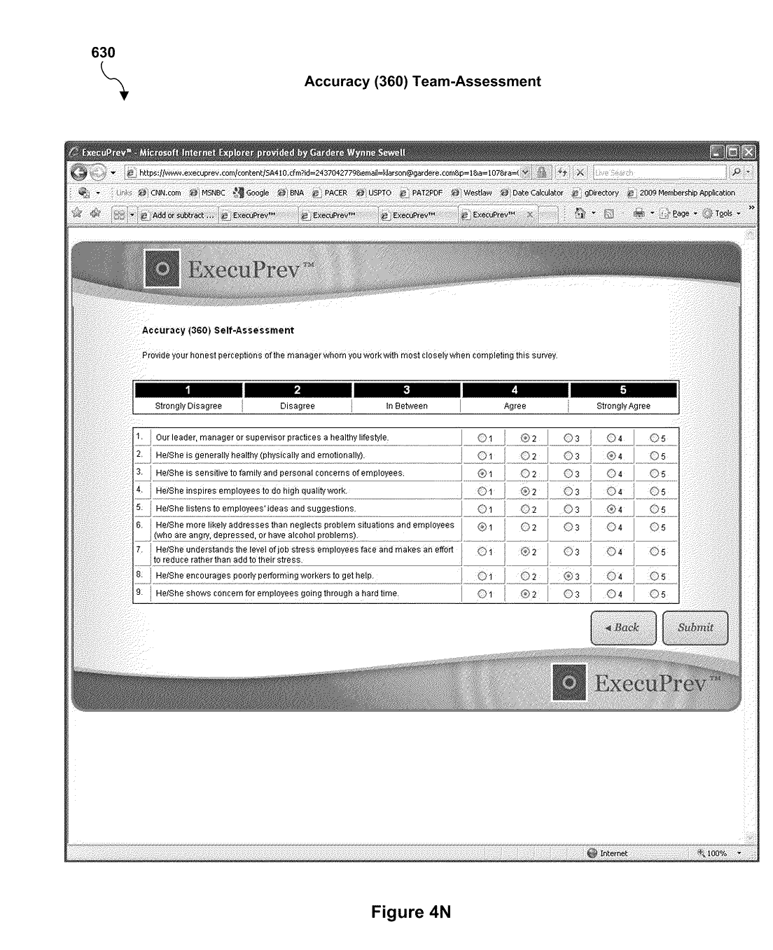

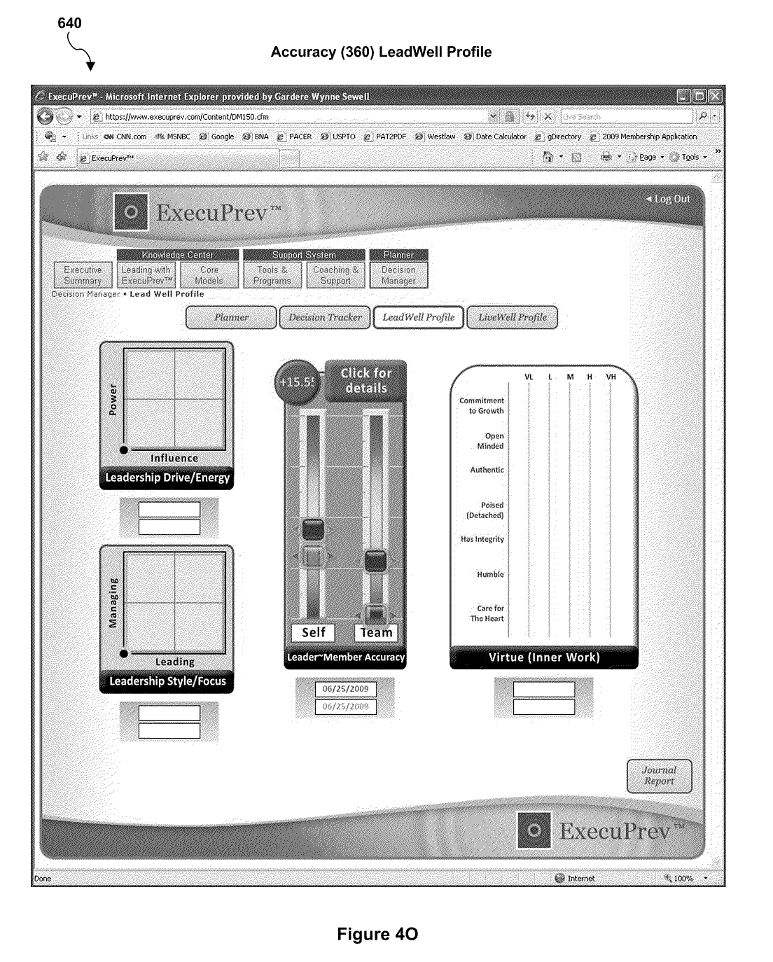

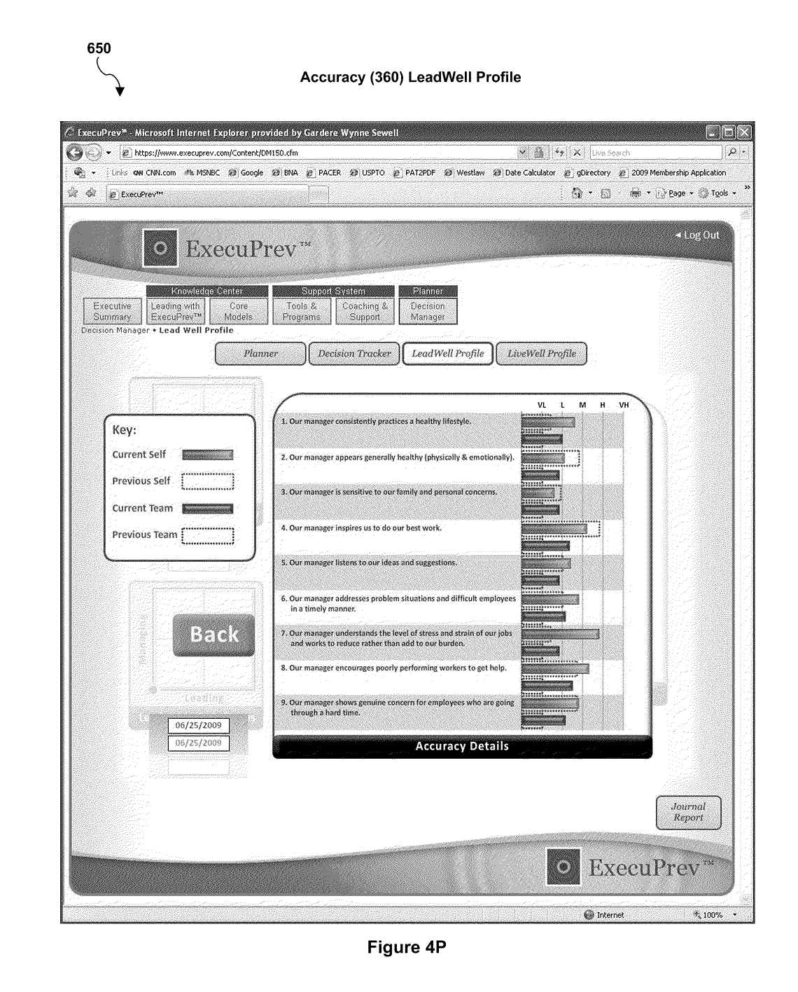

For example, the user may be presented with a series of web pages similar to the web page shown in FIG. 4A. Exemplary risks self-assessment results are depicted in the chart to the right of FIG. 4B may be presented to the user. As shown, a bar/score is presented for each of the four risk factors. These range from very low risks (which is preferred) to very high risks (which should be avoided). The legend for the chart is VL=very low; L=low; M=medium; H=high; and VH=very high. The particular score for each of the four risk factors can range from 5 (VL) to 25 (VH). The chart also adds the four factors to yield a total score, displayed in the red circle below the chart. This total score can range from 25 to 100. The higher the number, the greater the overall risk. In general, a score above 75 suggests a greater set of risks. The Achilles heel score is relatively stable since it is based on perceived genetic factors (i.e., disease presence in biological relatives).

### Risk-Reduction Simulator

As shown at block 134, the present invention includes a risk-reduction simulator. According to one embodiment, the risk-reduction simulator may be used by a leader as a forecasting tool. The risk reduction simulator guides a leader through a series of interactive questions related to without limitation: (1) perceived risks in the work place setting, (2) risks associated with the personal lifestyle of leaders and/or other members of the organization (e.g., smoking or obesity), (3) interest and effort required to reduce these risks, and (4) interest and effort required in the leader's own leadership development. As the leader answers questions using the risk-reduction simulator, the responses are plotted on a grid to graphically represent the leader's current level of risk, the amount of risk the leader can currently reduce and the leader's leadership as an added protective factor. This allows the leader to pause and assemble risk information, estimate where the leader's efforts can make the biggest difference in reducing risks and develop a sense of how the leader can make a difference. For example, the user may be presented with a web page similar to the web page shown in FIG. 4C.

### Return on Investment Estimator

As shown at block 136, the present invention includes a return on investment estimator. According to one embodiment, the return on investment estimator may be used by a leader as a forecasting tool. The return on investment estimator guides a leader through a series of interactive questions related to the leader's work climate and the potential savings associated with implementing wellness programs in the leader's work setting. Based on the leader's responses to the questions, estimates related to the organization's return on investment are calculated. The estimates include without limitation the financial return on investment relating to potential diseases within the organization, including financial costs and savings associated with heath care, productivity and absenteeism relating to those potential diseases within the organization. For example, the user may be presented with a series of web pages similar to those shown in FIGS. 4D-4G.

### Coaching & Support

As shown at block 150, the present invention includes coaching and support. According to one embodiment, coaching and support includes without limitation online support, webinars, telephonic support, assistance with tools and programs, and an expert video library.

### Leadership Development Through Accuracy Feedback (Team Builder Part I)

The present invention allows a leader to: (i) solicit input, (ii) compare data from different inputs, (iii) schedule as well as track on these data tasks, and (iv) utilize a curriculum for guidance on these tasks.

In one embodiment, leadership development is achieved through accuracy feedback, referred to herein as leader member accuracy or “LMA.” According to this embodiment, an online survey tool provides the leader with (i) a self-estimate on how the leader is perceived by the leader's peers and/or team members, (ii) feedback on how the leader is perceived by the leader's peers and/or team members, and (iii) a leadership curriculum to address any discrepancies or deficiencies identified through the accuracy measure. Specifically, a LMA survey captures perceptions of the leader as an effective manager of health and productivity. The leader is then provided discrepancy feedback in which the leader's perceptions as well as member perceptions are combined and displayed as leader versus member comparisons in several categories and as total score. The LMA is embedded in a curriculum that prepares the leader to complete the assessment to help assure that the leader is getting proper use of it and that the leader receives maximal benefit from its use.

The LMA includes without limitation one or more surveys in several categories in which the leader provides self-rating, feedback based on the results of the one or more surveys, team feedback of one or more team members (e.g., three team members), comparisons between the leader and the aggregated display of team member ratings, and a leadership curriculum to address any discrepancies or deficiencies identified through the accuracy measure.

The one or more surveys involved in the leader's self-rating include an accuracy perceived versus actual impact survey. According to one embodiment, the leader receives visual feedback of their results: (i) immediately upon completion of the one or more surveys, and (ii) in the LeadWell Profile, where the display is seen in context with visual feedback from other LeadWell self-assessments. Both the immediate feedback and the LeadWell profile actively store the data for visual display so that the leader can return at a later time and see their previous score and, if desired, re-take one or more surveys to reflect the leader's changes over time. For example, the leader may be presented with a series of web pages to those shown in FIGS. 4J-4L. Self-assessment selections in different categories are depicted in FIG. 4J. Self-assessment results are depicted in FIGS. 4J and 4K. The leader's own ratings (both current and previous) alongside the aggregated or averaged ratings of team members who anonymously rated the leader for each items of the survey is depicted in FIG. 4L.

A planned start of one or more activities, including the planned start of the LMA, may be scheduled and retained in a leader's calendar. According to one embodiment, these activities include without limitation reviewing LeadWell lessons and completing take action assignments, and reviewing LeadWell assessment results, leadership motivation, leadership style, virtues, LMA, and taking further action through curriculum on contemplate virtues, practice principles, and work through feedback. This date is automatically stored in without limitation an activity planner in the form of a visual calendar, and an activity reminder the leader is shown at start-up screen upon re-entry in the system. In addition, the leader can place the scheduled activity as a reminder in Microsoft Outlook using, for instance, an iCalendar applet.

A decision tracker displays assessment results upon completion of an LMA. One or more invitations may be sent to the leader's peers and/or team members to complete a survey regarding the leader. The one or more peers and/or team members are identified by the leader, such as by specifying e-mail addresses, and a communication is electronically sent to these individuals, inviting them to complete the LMA, such as by e-mail. In one embodiment, the predefined content of the letter may be updated and/or replaced by the leader. The e-mail is actually sent from the computer system rather than the manager, to help assure the confidentiality of the respondents' answers.

After receiving the invitation, each respondent (associate, subordinate) completes the survey. As the employees complete the survey, their data is stored into a database. The average of all employee respondents is calculated and visually displayed. The average is presented both as a total score (averaged across 9 items) as well as for each of the 9 items.

The user can check on the status of the number of employees completing the survey. No names of any employees or other identifying information is accessible to the user. The user is able to compare his or her visual display right alongside the display showing the average score as noted.

The user can schedule a LMA by setting a date in their calendar. According to one embodiment, the date is automatically stored in two places: (a) the activity planner (visual calendar displayed), and (b) the activity reminder (upon re-entry, the user sees a start-up screen that reminds them of the date). In addition, the user can place the scheduled activity as a reminder in Microsoft Outlook.

The computer program registers the user's activities, including when the user shows interest, plans, and completes the LMA. The computer program also keeps track of, and monitor, when the user completes activities, and how many employees have: (a) been invited, and (b) have completed the LMA.

### Leadership Development Through Support Programs (Team Builder Part II)

The present invention allows a leader to: (i) utilize one or more of any number of health promotion programs, (ii) complete activities in those programs that represent milestones, (iii) through email invitation, encourage others (staff, subordinates, associates) to use those or similar programs, and (iv) track the overall number of invitees who respond to the encouragement.

In one embodiment, health promotion is achieved through providing leaders and/or other members of an organization access to online health promotion programs, referred to as “online health promotion.” These can be programs already offered by the organization or new programs situated into ExecuPrev™ on an ongoing or updated basis. According to this embodiment, an online health promotion provides the leader with (i) access to health curricula across a diverse set of concerns that include, but are not limited to, stress, exercise, diet, and mood, (ii) guidelines and support—including coaching—for using the curricula and achieving behavioral outcomes, and (iii) a leadership curriculum to encourage associates to use same or similar programs, with direct ability to send automated e-mail invitations to associates with links to the same online health promotion. Specifically, the online health promotion is embedded in a curriculum that prepares the leader to first use the programs him or herself and then craft invitations to others.

Similar to electronic invitations in the LMA, the leader invites other members of an organization to participate in the health promotion program via an electronic mail process that involves three steps in the Team Builder section of the ExecuPrev™ program: (1) leaders select one of the health promotion activities and provide e-mail addresses of members of the organization (i.e., the invitees); (2) leaders craft and send an e-mail alerting members of the organization that they will be receiving an e-mail invitation from a third-party and they also select one of several customized e-mail invitations to members of the organization. These invitations contain embedded links to the program such that (a) members of the organization can directly access the online health program, and (b) the system records whether members of the organization access the program; and (3) leaders review the e-mail prior to sending and have the option of printing out paper versions of the invitation for members of the organization. FIG. 4M provides a representative example of these steps according to one embodiment.

Beyond the above identified concepts, the present invention also offers multimedia options, storage of multiple users' information, report generation from multiple users, coaching, and interactive education.

The processes and mechanisms set forth in the present description may be implemented using a conventional general purpose microprocessor, or silicon as part of a graphics accelerator chip and/or subsystem, programmed according to the teachings in the present specifications, as will be appreciated to those skilled in the relevant art. Appropriate software can be prepared based upon the teachings of the present disclosure, as will also be apparent to those skilled in the relevant arts.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer system for managing a leadership and health development program, comprising:
a network configured to provide a plurality of members of an organization access to the computer system, wherein at least one of the plurality of members is a leader;
a computer having a web server configured to provide a plurality of web pages over the network,
a database in communication with the web server and having a plurality of leadership and health and wellness programs targeted toward the at least one leader; and
wherein the web server is configured to deliver one or more leader surveys in a plurality of health and wellness categories and a plurality of leadership and management categories to the at least one leader via the plurality of web pages, receive a plurality of leader responses corresponding to the one or more leader surveys from the at least one leader, calculate a first leader level of health and leadership in different dimensions of the at least one leader based on the plurality of leader responses, and graphically represent and deliver the first leader level of health and leadership to the at least one leader via the plurality of web pages.

2. The computer system of claim 1, wherein the computer is configured to communicate with at least one other member of the plurality of members to participate in one or more member surveys in a plurality of health and wellness categories and a plurality of leadership and management categories, and the one or more member surveys relate to the at least one leader.

3. The computer system of claim 2, wherein the web server is further configured to deliver the one or more member surveys to the at least one other member via the plurality of web pages, receive a plurality of member responses corresponding to the one or more member surveys from the at least one other member, calculate a second leader level of health and leadership in different dimensions of the at least one leader based on the plurality of member responses, and to graphically represent and deliver the second leader level of health and leadership to the at least one leader via the plurality of web pages.

4. The computer system of claim 3, wherein the web server is further configured to identify one or more health risks and one or more health strengths of the at least one leader based on the plurality of leader responses, and to graphically represent the one or more health risks and the one or more health strengths via the plurality of web pages.

5. The computer system of claim 4, wherein the one or more health risks consist of at least one selected from a group risk of the organization, a risk associated with a personal lifestyle of the one or more members, and an interest and effort required to reduce the health risks.

6. The computer system of claim 1, wherein an activity planner is delivered to the at least one leader via the plurality of web pages.

7. The computer system of claim 6, wherein the activity planner is configured to schedule the one or more leader surveys and the one or more member surveys.

8. The computer system of claim 1, wherein the plurality of health and wellness categories and the plurality of leadership and management categories consist of at least one selected from the group consisting of an Achilles heel category, a workload category, a crises category, and a lonely at the top category, a fitness category, a leader network category, a stress management category, a spiritual category, a ethical category, a physical category, a psychological category, and a personal leadership vitality and organizational vitality category.

9. The computer system of claim 3, wherein the plurality of leader responses and the plurality of member responses each include a plurality of numerical scores for each of the plurality of health and wellness categories and the plurality of leadership and management categories, and the first leader level of health and leadership is calculated by comparing the plurality of numerical scores with a plurality of pre-defined numerical equations.

10. A method of managing and providing a leadership and health development program to a plurality of members of an organization, wherein at least one of the plurality of members is a leader, wherein the method is implemented by one or more processors executing processor instructions stored on a computer readable medium, the method comprising the following processor implemented steps of:
providing a web server configured to provide a plurality of web pages over a network;
delivering one or more leader surveys in a plurality of health and wellness categories and a plurality of leadership and management categories over the network to the at least one leader via the plurality of web pages;
receiving a plurality of leader responses corresponding to the one or more leader surveys from the at least one leader;
calculating a first leader level of health and leadership in different dimensions of the at least one leader based on the plurality of leader responses; and
graphically representing and delivering the first leader level of health and leadership to the at least one leader via the plurality of web pages.

11. The method of claim 10, further comprising communicating with at least one other member of the plurality of members to participate in one or more member surveys in a plurality of health and wellness categories and a plurality of leadership and management categories, wherein the one or more member surveys relate to the at least one leader.

12. The method of claim 11, further comprising:
delivering the one or more member surveys to the at least one other member via the plurality of web pages;
receiving a plurality of member responses corresponding to the one or more member surveys from the at least one other member;
calculating a second leader level of health and leadership in different dimensions of the at least one leader based on the plurality of member responses; and
graphically representing and delivering the second leader level of health and leadership to the at least one leader via the plurality of web pages.

13. The method of claim 12, further comprising:
identifying one or more health risks and one or more health strengths of the at least one leader based on the plurality of leader responses; and
graphically representing and delivering the one or more health risks and the one or more health strengths to the at least one leader via the plurality of web pages.

14. The method of claim 13, wherein the one or more health risks consist of at least one selected from a group risk of the organization, a risk associated with a personal lifestyle of the one or more members, and an interest and effort required to reduce the health risks.

15. The method of claim 10, further comprising delivering an activity planner to the at least one leader via the plurality of web pages.

16. The method of claim 15, wherein the activity planner is configured to schedule the one or more leader surveys and the one or more member surveys.

17. The method of claim 10, wherein the plurality of health and wellness categories and the plurality of leadership and management categories consist of at least one selected from the group consisting of an Achilles heel category, a workload category, a crises category, and a lonely at the top category, a fitness category, a leader network category, a stress management category, a spiritual category, a ethical category, a physical category, a psychological category, and a personal leadership vitality and organizational vitality category.

18. The method of claim 12, wherein the plurality of leader responses and the plurality of member responses each include a plurality of numerical scores for each of the plurality of health and wellness categories and the plurality of leadership and management categories, and the calculating step includes a comparison of the plurality of numerical scores with a plurality of pre-defined numerical equations.
